(19) United States
(12) Patent Application Publication
(10) Pub. No.: US 2014/0317254 A1
(43) Pub. Date: Oct. 23, 2014

(54) MANAGEMENT COMPUTER, AUTOMATED OPERATION PROCEDURE OUTPUT METHOD, AND COMPUTER-READABLE STORAGE MEDIUM

(71) Applicants: Daisuke Iizuka, Tokyo (JP); Kiminori Sugauchi, Tokyo (JP)

(72) Inventors: Daisuke Iizuka, Tokyo (JP); Kiminori Sugauchi, Tokyo (JP)

(73) Assignee: HITACHI, LTD., Tokyo (JP)

(21) Appl. No.: 14/358,595

(22) PCT Filed: Jan. 27, 2012
(86) PCT No.: PCT/JP2012/051856

§ 371 Date: May 15, 2014

(51) Int. Cl. H04L 12/24

(52) U.S. Cl. CPC H04L 41/0813
USPC 709/221

(57) ABSTRACT

A management computer manages a resource to be managed and outputs an operation procedure to be automated from an operation procedure included in an operation for changing a configuration of the resource to be managed. The operation procedure includes a manual procedure and an automatic execution procedure. The management computer stores time information including an initiation time of initiating the operation procedure and a termination time of terminating the operation procedure and time-series information about the resource to be managed. The management computer acquires time-series information corresponding to the time information of the operation procedure from the time-series information, determinates whether the operation procedure takes time mainly for the manual procedure or takes time mainly for the automated procedure based on the acquired time-series information, and outputs the determination result.

### BACKGROUND

The present invention relates to a management computer for managing a resource to be managed, and more particularly to a management computer for outputting an operation procedure to be automated.

In the operation of an information processing system including an IT (Information Technology) resource including at least one of a server device, a network device, or a storage device, an operation for modifying a configuration of the IT resource (hereinafter, referred to as a configuration modification operation) is necessary. This configuration modification operation includes, for example, software installation and setup in which parameters are set by an operator.

The configuration modification operation involves a manual operation of the operator. An operation time of the manual operation occasionally extends due to an additional operation for operation errors resulting from inexperience and carelessness of the operator. To prevent this circumstance, the following automated processing is becoming widespread: a manual operation is previously converted into an automatic operation flow such as a script and the like; then, a few parameters are provided and the automatic operation flow is executed; and thereby, the manual operation is reduced and also a time taken for a configuration modification operation is shortened.

The configuration modification operation includes at least one operation procedure. The conversion of these operation procedures into automated processing needs much effort and time. The reason is that it is necessary that a system administrator or the like converting the operation procedures into automated processing examine a CLI (Command Line Interface) and an API (Application Program Interface) executing the same processing as a procedure input by the operator via a GUI (Graphical User Interface) in the configuration modification operation and further consider abnormal processing.

Therefore, it is desirable that all operation procedures included in the configuration modification operation are not converted into automated processing but a part of the operation procedures are converted into automated processing. In this case, it is conceivable that as an indicator for determining which operation procedure needs to be converted into automated processing, a time taken for an individual operation procedure is measured.

Unexamined Japanese Patent Application Publication No. 2003-256624 (hereinafter, referred to as Patent Document 1), for example, discloses a technique, in which a maintenance management server receives maintenance separation information from a mobile terminal carried by a maintenance person before and after executing a test program to specify an initiation time and a termination time of a maintenance operation. Further, Unexamined Japanese Patent Application Publication No. 2011-215977 (hereinafter, referred to as Patent Document 2), for example, discloses a technique, in which in an operation including a manual procedure of an operator and an automatic procedure executed by a setup tool or the like following the manual procedure, a check procedure is previously defined to measure a time taken for the manual procedure.

### SUMMARY

An operation procedure includes a procedure on a system side and a procedure manually operated by an operator. Processing on the system side takes time and as a result, a time taken for the operation procedure occasionally extends. Examples of the processing taking time on the system side include copy processing of data, backup processing of data, and the like. When much processing time on the system side is necessary with respect to an operation time of a certain operation procedure, the conversion of a procedure manually operated by an operator into automated processing produces merely a small effect for shortening the operation time of the operation procedure. Therefore, when determining an operation procedure for the conversion into automated processing, the system administrator needs to consider the processing time on the system side.

Patent document 1 does not consider the processing time on the system side. Further, in Patent Document 2, upon executing the same operation at a plural number of times, although there is a case where the processing time on the system side varies due to a change in a data size to be processed and the like, the processing time of an automatic procedure is considered constant. Therefore, in Patent Document 2, it is difficult to correctly detect the processing time on the system side.

An object of the present invention is to provide a management computer making it easy that the system administrator determines an operation procedure for the conversion into automated processing in view of a processing time on the system side.

One typical example of the invention disclosed in the present application is described as follows. A management computer for managing a resource to be managed including at least one of a server device, a storage device, or a network device and for outputting an operation procedure to be automated from an operation procedure included in an operation for changing a configuration of the resource to be managed, the operation procedure including a manual procedure that is a procedure manually operated by an operator and an automatic execution procedure where the resource to be managed executes configuration modification processing, the management computer comprising: a storage area for storing time information including an initiation time of initiating the operation procedure and a termination time of terminating the operation procedure and time-series information about the resource to be managed output by the resource to be managed; and a processor for referring to the time information and the time-series information, the processor acquiring time-series information corresponding to the time information of the operation procedure from the time-series information, determining whether the operation procedure takes time mainly for the manual procedure or takes time mainly for the automated procedure based on the acquired time-series information, and outputting the determination result.

According to one embodiment of the present invention, it is possible to provide a management computer making it easy that the system administrator determines an operation procedure for the conversion into automated processing in view of a processing time on the system side.

### BRIEF DESCRIPTION OF THE DRAWINGS

FIG. 1 is an illustrative view of a configuration of an information processing system of a first embodiment of present invention.

FIG. 2 is a block diagram illustrating a hardware configuration of a management server of the first embodiment of the present invention.

FIG. 3 is an illustrative view of a operation list table of the first embodiment of the present invention.

FIG. 4 is an illustrative view of a procedure history list table of the first embodiment of the present invention.

FIG. 5 is an illustrative view of a performance history list table of the first embodiment of the present invention.

FIG. 6 is an illustrative view of a performance threshold list table of the first embodiment of the present invention.

FIG. 7 is an illustrative view of a configuration information list table of the first embodiment of the present invention.

FIG. 8 is a flowchart of operation procedure determination processing of the first embodiment of the present invention.

FIG. 9 is an illustrative view of a GUI screen displayed in an output device of the first embodiment of the present invention.

FIG. 10 is an illustrative view of a monitoring log file list of the second embodiment of the present invention.

FIG. 11 is a flowchart of operation procedure determination processing of the second embodiment of the present invention.

FIG. 12 is a flowchart of operation procedure determination processing of the third embodiment of the present invention.

### DESCRIPTION OF THE EMBODIMENTS

With reference to the drawings, embodiments of the present invention will now be described. For clear description, the following description and drawings are appropriately omitted and simplified. Further, in the drawings, the same sign is assigned to the same element, and overlapping description is omitted as appropriate for clear description.

In the following description, description is occasionally made by regarding a “program” as the subject. However, since the program executes processing specified by being executed by a processor using a memory and a communication port (communication control interface), description may be made by regarding the processor as the subject. Further, processing disclosed by regarding the program as the subject may be considered processing executed by a computer such as a management server and the like and an information processing device. Further, a part or all of the program may be realized by a dedicated hardware.

Further, various types of programs included in the program may be installed on respective computers by a program distribution server and a computer-readable storage medium.

### First Embodiment

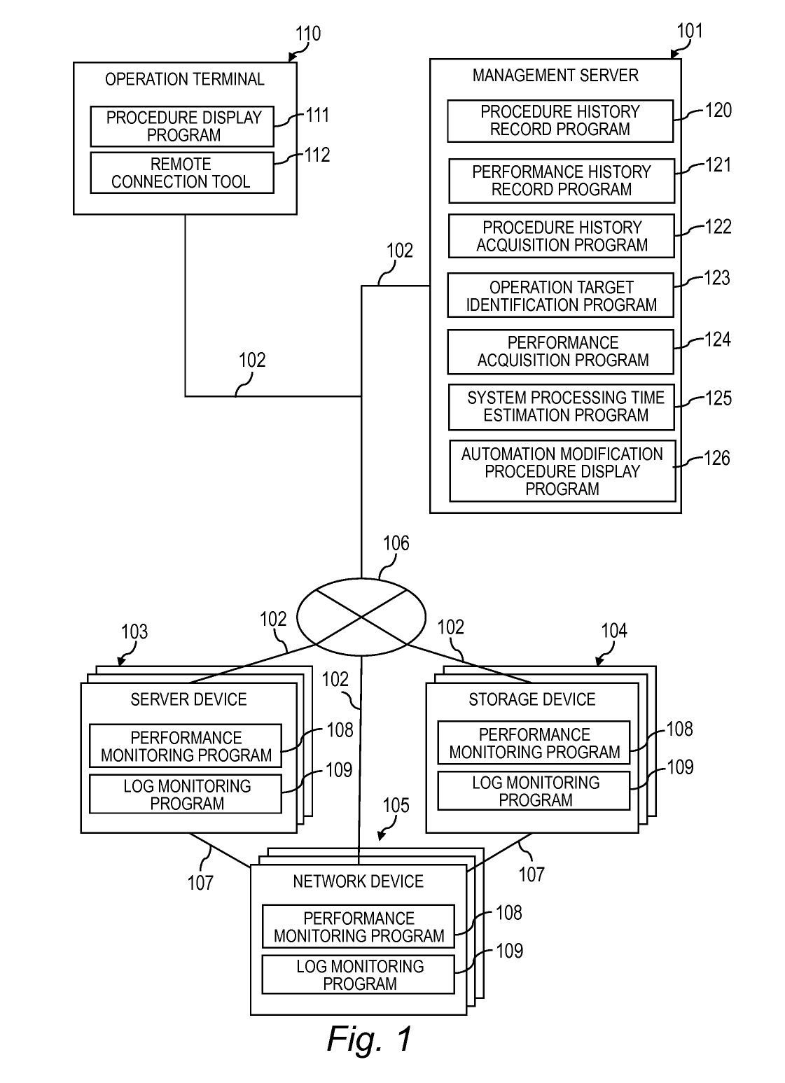

The first embodiment of the present invention will be described below with reference to FIG. 1 to FIG. 9.

FIG. 1 is an illustrative view of a configuration of an information processing system of the first embodiment of the present invention.

The information processing system includes a management server (management computer) 101, an operation terminal 110, a server device 103, a storage device 104, and a network device 105.

The management server 101, the operation terminal 110, the server device 103, the storage device 104, and the network device 105 are connected to a management network 106 via a link 102. The server device 103 and the storage device 104 are connected to the network device 105 via a link 107.

The link 102 and the link 107 are a wired or wireless connection system, and may include at least one subnetwork and a VPN (Virtual Private Network). The management server 101, the operation terminal 110, the server device 103, the storage device 104, and the network device 105 may be connected to the management network 106 or the network device 105 by different systems. The storage device 104 and the server device 103 may be directly connected via a wired or wireless connection system without the network device 105.

The server device 103, the storage device 104, and the network device 105 are resources to be managed, which is managed by the management server 101. The resource to be managed is a device whose configuration is modified by a configuration modification operation. The configuration modification operation includes at least one operation procedure, and the operation procedure includes a procedure (manual operation) manually operated by an operator and a procedure (automatic execution procedure) automatically executing configuration modification processing for causing the resource to be managed to modify its own configuration. The resource to be managed holds time-series information on the configuration modification processing executed by itself. In the present embodiment, since the time-series information is performance information such as a CPU usage rate of the resource to be managed and the like, in the following description of the present embodiment, the time-series information on configuration modification processing is referred to as performance information.

The resource to be managed includes a performance monitoring program 108 and a log monitoring program 109. These programs are stored on a memory, not illustrated, included in the resource to be managed, and executed by a processor, not illustrated, included in the resource to be managed. The performance monitoring program 108 monitors performance information by storing performance information on the memory, not illustrated, of the resource to be managed. The log monitoring program 109 monitors a monitoring log by storing a monitoring log, to be described in the second embodiment, on the memory, not illustrated, of the resource to be managed.

The management server 101 acquires performance information from the resource to be managed and determines which one of a time taken for a manual procedure and a time taken for an automatic execution procedure is spent more in an operation time taken for operation procedures, based on the acquired performance information. Then, the management sever 101 outputs an operation procedure to be automated based on the determination result.

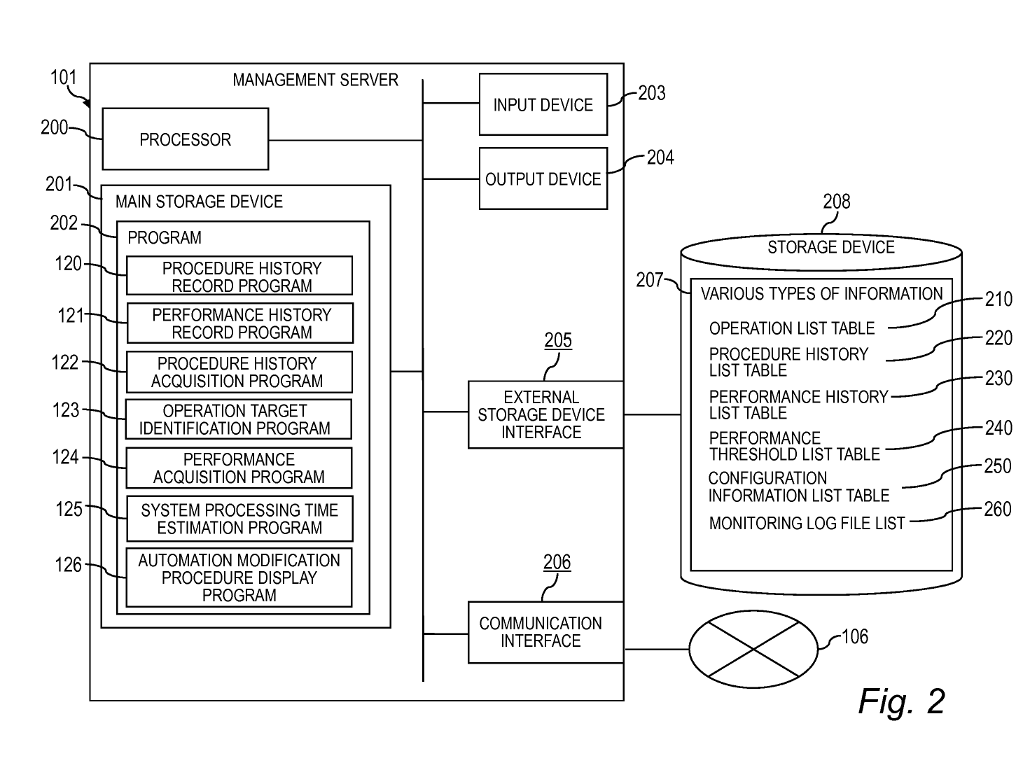

The management server 101 includes a procedure history record program 120, a performance history record program 121, a procedure history acquisition program 122, an operation target identification program 123, a performance acquisition program 124, a system processing time estimation program 125, and an automation modification procedure display program 126. These are illustrated in detail in FIG. 2.

The operation terminal 110 is a computer operated by an operator and includes a procedure display program 111 and a remote connection tool 112. These are stored on a memory, not illustrated, included in the operation terminal 110 and executed by a processor, not illustrated, included in a resource to be managed. Via a screen displayed by the procedure display program 111, the operator operates a manual procedure. The manual procedure is, for example, a procedure for inputting various types of parameters of configuration modification processing and the like. The remote connection tool 112 is a tool for remotely operating the resource to be managed and will be described in detail in the third embodiment.

FIG. 1 has exemplarily illustrated the server device 103, the storage device 104, and the network device 105 as a plurality of units for each device but a single unit is employable for each device. The resource to be managed needs only to include at least one of the server device 103, the storage device 104, or the network device 105, and therefore, any one or ones of the server device 103, the storage device 104, and the network device 105 that are not included in the resource to be managed may not exist. Further, FIG. 1 has exemplarily illustrated the management server 101 and the operation terminal 110 as a single unit for each device but a plurality of units are employable for each device. Further, when, for example, the operator is able to operate a manual procedure via the management server 101, the operation terminal 110 may not exist.

Further, the management server 101, the operation terminal 110, the server device 103, the storage device 104, and the network device 105 each may be a virtual machine. Further, at least two of the management server 101, the operation terminal 110, the server device 103, the storage device 104, and the network device 105 may be mounted in the same housing or the same virtual machine.

The network device 105 may be connected to another network device 105 via a wired or wireless connection system. Further, a network provided by the network device 105 may be the same as the management network 106. Further, the link 102 and the link 107 may be the same.

FIG. 2 is a block diagram illustrating a hardware configuration of the management server 101 of the first embodiment of the present invention.

The management server 101 includes a processor (CPU: Central Processing Unit) 200, a main storage device (memory) 201, an input device 203, an output device 204, an external storage device interface 205, and a communication interface 206.

The processor 200 executes a program 202 stored on the main storage device 201. The main storage device 201 stores the program 202. The program 202 includes the procedure history record program 120, the performance history record program 121, the procedure history acquisition program 122, the operation target identification program 123, the performance acquisition program 124, the system processing time estimation program 125, and the automation modification procedure display program 126.

The procedure history record program 120 registers information on an operation procedure operated by an operator in a procedure history list table 220 (see FIG. 2).

The performance history record program 121 registers performance information acquired from a resource to be managed in a performance history list table 230 (see FIG. 2).

The performance history acquisition program 122 acquires information indicating an operation procedure to be processed from the procedure history list table 220.

The operation target identification program 123 identifies resources to be managed having a possibility of having been applied with configuration modification processing by the operation procedure indicated by the information acquired by the procedure history acquisition program 122.

The performance acquisition program 124 acquires, from the performance history list table 230, performance information corresponding to the operation procedure acquired by the procedure history acquisition program 122 among performance information of the resources to be managed identified by the operation target identification program 123.

The system processing time estimation program 125 determines whether the operation procedure acquired by the procedure history acquisition program 122 has spent time mainly for a manual procedure or mainly for an automatic execution procedure, based on the performance information acquired by the performance acquisition program 124.

The automation modification procedure display program 126 displays an operation procedure to be automated based on the determination result obtained by the system processing time estimation program 125.

Examples of the input device 203 are thought to include a keyboard and a pointer device but a device other than these is employable. Further, examples of the output device 204 are thought to include a display but a device other than this is employable. Further, as an alternative of the input device 203 and the output device 204 (hereinafter, referred to collectively as an input output device), the following is employable to substitute an input and an output in an input device: a serial interface or an Ethernet interface is used as an input output device; the interface is connected with a display computer including a display, a keyboard, or a pointer device; then output information (display information) is transmitted to the display computer or input information is received from the display computer; and thereby the display computer displays the output information or receives an input.

Hereinafter, a set of at least one computer managing an information management system and displaying the display information of the present invention is referred to as a management system in some cases. When the management server 101 displays display information, the management server 101 is a management system. Further, a combination of the management server 101 and a display computer is also a management system. Further, for speeding-up and reliability enhancement of management processing, a plurality of computers may realize the same processing as a management computer, and in this case, the plurality of computers (including a display computer when the display computer performs display) configures a management system.

The external storage device interface 205 is an interface for connecting the management server 101 to a storage device 208.

The storage device 208 stores various types of information 207. The various types of information 207 includes an operation list table 210, a procedure history list table 220, a performance history list table 230, a performance threshold list table 240, a configuration information list table 250, and a monitoring log file list 260.

In the following description, these tables 210 to 250 will be described as the expression “a table.” These tables 210 to 260 are not limited by a data structure of the table and may be expressed using a data structure such as a list, a DB, a queue, and the like. Further, these tables 210 to 260 may be expressed using a data structure other than a table, a list, a DB, and a queue. To indicate the independence of the data structure, each of the tables 210 to 250 (“aaa table”) is occasionally referred to as “aaa information.”

Further, when the content of each information is described, the expression “identification information,” “identifier,” “designation,” “name,” or “ID” is used and these are replaceable with each other.

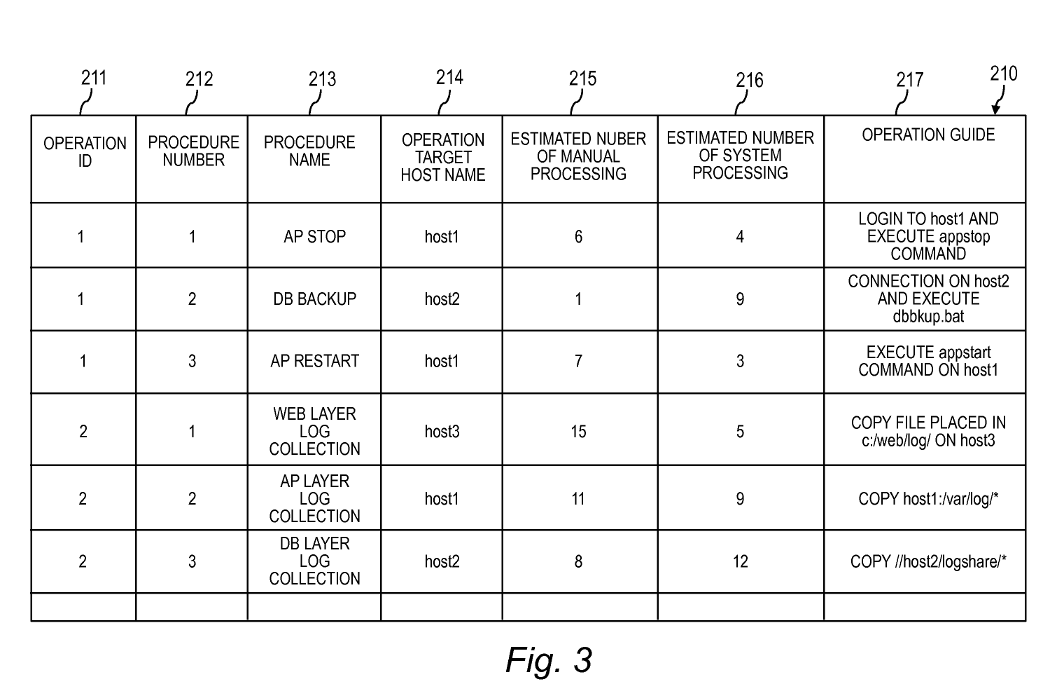

The operation list table 210 registers information indicating what operation an operator performs for which object with respect to a series of configuration modification operations for a resource to be managed including at least one of the server device 103, the storage device 104, or the network device 105. The operation list table 210 will be described in detail in FIG. 3.

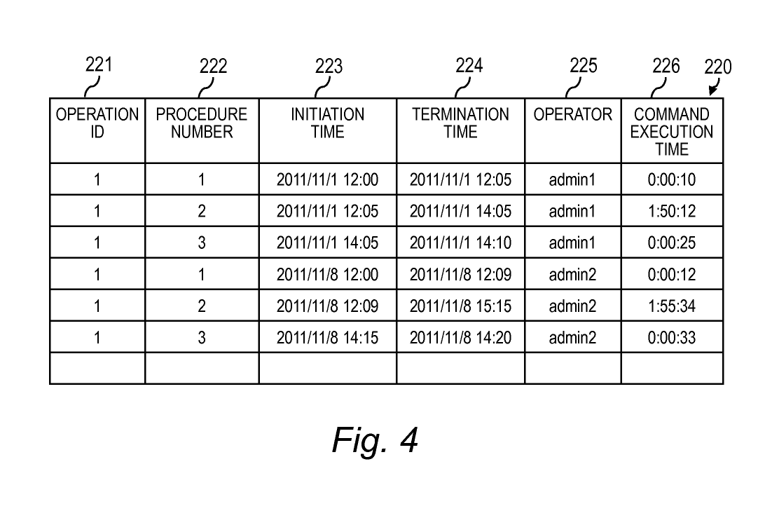

The procedure history list table 220 resisters an initiation time, a termination time, and others of each operation procedure included in each operation. The procedure history list table 220 will be described in detail in FIG. 4.

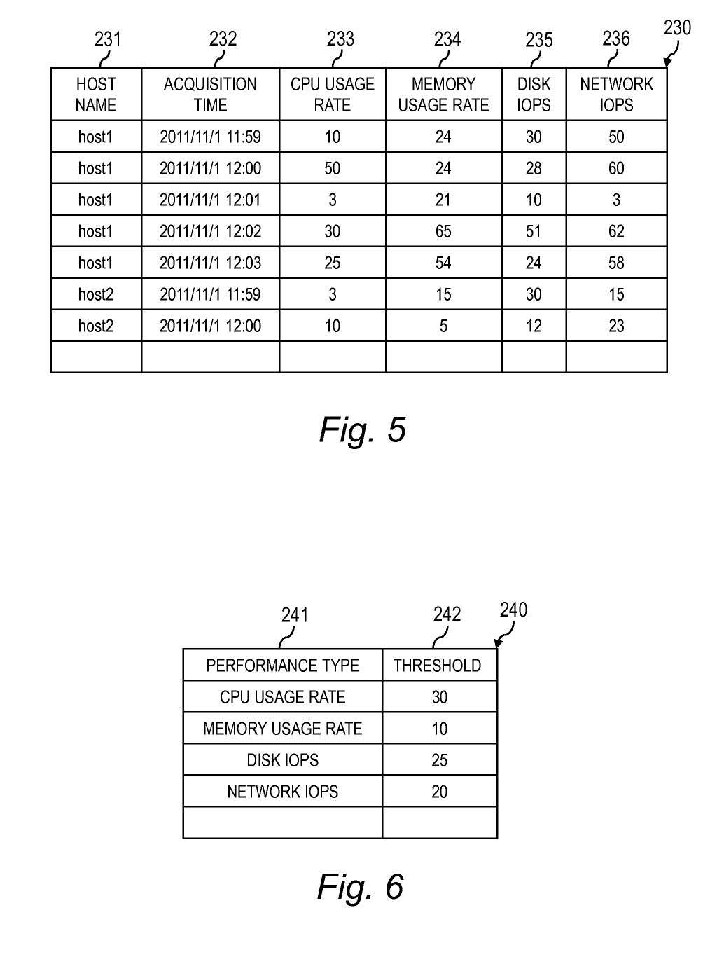

The performance history list table 230 registers performance information of a resource to be managed in chronological order. The performance history list table 230 will be described in detail in FIG. 5.

The performance threshold list table 240 registers a threshold according to a type of performance information. The performance threshold list table 240 will be described in detail in FIG. 6.

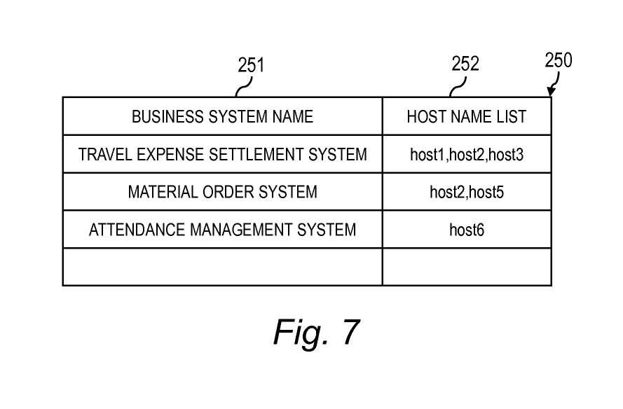

The configuration information list table 250 registers a resource to be managed configuring each business system. The configuration information list table 250 will be described in detail in FIG. 7.

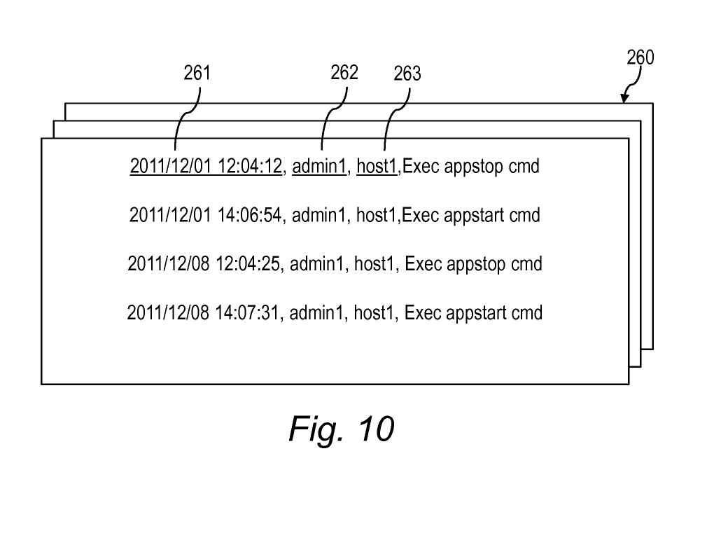

The monitoring log file list 260 registers information on a monitoring log file acquired from a resource to be managed. The monitoring log file list 260 is not used in the present embodiment but used in the second embodiment. The monitoring log file list 260 will be described in detail in FIG. 10.

The communication interface 206 is an interface for connecting the management server 101 to the management network 106.

The communication interface 206 and the external storage device interface 205 may be the same interface.

Further, FIG. 2 has illustrated a case in which the storage device 208 is connected to the exterior of the management server 101, but the storage device 208 may be connected to the interior of the management server 101.

The management server 101 may not include the procedure history record program 120 or the performance history record program 121.

Further, the storage device 208 may not store at least one of the operation list table 210, the procedure history list table 220, the performance history list table 230, the performance threshold list table 240, the configuration information list table 250, or the monitoring log file list 260. Further, the main storage device 201 may store at least one of the operation list table 210, the procedure history list table 220, the performance history list table 230, the performance threshold list table 240, the configuration information list table 250, or the monitoring log file list 260 stored on the storage device 28.

FIG. 3 is an illustrative view of the operation list table 210 of the first embodiment of the present invention.

The operation list table 210 includes an operation ID 211, a procedure number 212, a procedure name 213, an operation target host name 214, an estimated number of manual processing 215, an estimated number of system processing 216, and an operation guide 217.

The operation ID 211 registers unique identification information of each operation. The procedure number 212 registers unique identification information of an operation procedure. The procedure name 213 registers a name of an operation procedure that can be grasped by an operator. The operation target host name 214 registers identification information of a host serving as an operation target of the operator. The host refers to a collective name of the storage device 104, the server device 103, and the network device 105 configuring a resource to be managed.

The estimated number of manual processing 215 registers a number of times in which the management server 101 determines that an operation procedure has taken time mainly for a manual procedure. The estimated number of system processing 215 registers a number of times in which the management server 101 determines that an operation procedure has taken time mainly for an automatic execution procedure. The operation guide 217 registers the content of an operation procedure as a character string.

The system administrator previously sets the operation ID 211, the procedure number 212, the procedure name 213, the operation target host name 214, and the operation guide 217. The management server 101 updates the estimated number of manual processing 215 and the estimated number of system processing 216. The system administrator may set the operation ID 211, the procedure number 212, the procedure name 213, the operation target host name 214, and the operation guide 217 manually or using some kind of tool or utility.

Further, the operation list table 210 may include a column other than the operation ID 211, the procedure number 212, the procedure name 213, the operation target host name 214, the estimated number of manual processing 215, the estimated number of system processing 216, and the operation guide 217 and may not necessarily include all of the operation ID 211, the procedure number 212, the procedure name 213, the operation target host name 214, the estimated number of manual processing 215, the estimated number of system processing 216, and the operation guide 217.

FIG. 4 is an illustrative view of the procedure history list table 220 of the first embodiment of the present invention.

The procedure history list table 220 includes an operation ID 221, a procedure number 222, an initiation time 223, a termination time 224, an operator 225, and a command execution time 226.

The operation ID 221 registers unique identification information of each operation. The procedure number 222 registers unique identification information of an operation procedure.

The initiation time 223 registers an initiation time of an operation procedure. The termination time 224 registers a termination time of the operation procedure. A time from the time registered in the initiation time 223 and the time registered in the termination time 224 is an operation time of the operation procedure.

The operator 225 registers identification information of an operator having operated a manual setting procedure of an operation procedure. The command execution time 226 registers a difference between a time of a command input performed by the operator using the remote connection tool 112 and a time of reception of a response to the command from a resource to be managed as a time taken execute the command by the resource to be managed. The command execution time 226 is not used in the present embodiment but used in the third embodiment. Therefore, the procedure history list table 220 of the present embodiment may not include the command execution time 226.

Information registered in the procedure history list table 220 is related to information registered in the operation list table 210, using identification information registered in the operation ID 221 and the procedure number 222 and identification information registered in the operation ID 211 and the procedure number 212 of the operation list table 210 as keys.

The procedure history list table 220 is updated every time an operation procedure is terminated. Update processing of the procedure history list table 220 is specifically described below. An operator operates a manual procedure via the procedure display program 111 of the operation terminal 110. When receiving a predetermined operation indicating the termination of an operation procedure, the procedure display program 111 transmits procedure history update information including an operation ID of the manual procedure, an initiation time and a termination time of the operation procedure, and identification information of the operator to the procedure history record program 120 of the management server 101. When receiving the procedure history update information, the procedure history record program 120 registers the received procedure history update information in the procedure history list table 220.

The system administrator may update the procedure history list table 220 at a predetermined timing manually or using some kind of tool or utility.

Further, the procedure history list table 220 may include a column other than the operation ID 221, the procedure number 222, the initiation time 223, the termination time 224, the operator 225, and the command execution time 226 and may not necessarily include all of the operation ID 221, the procedure number 222, the initiation time 223, the termination time 224, the operator 225, and the command execution time 226.

FIG. 5 is an illustrative view of the performance history list table 230 of the first embodiment of the present invention.

The performance history list table 230 includes a host name 231, an acquisition time 232, a CPU usage rate 233, a memory usage rate 234, a disk IOPS (Input Output Per Second) 235, and a network IOPS 236.

The host name 231 registers identification information of a host configuring a resource to be managed. The acquisition time 232 registers a time of acquiring performance information of the host by the management server 101.

The CPU usage rate 233, the memory usage rate 234, the disk IOPS 235, and the network IOPS 236 are performance information of a host. The CPU usage rate 233 registers a usage rate of a CPU included in the host. The memory usage rate 234 registers a usage rate of a memory included in the host. The disk IOPS 235 registers an IOPS of a disk device included in the host. The network IOPS 236 registers an IOPS of a network used by the host.

The performance history list table 230 may include a usage amount of a CPU included in a host, a queue length of a processor included in the host, a usage amount of a memory included in the host, a band usage amount of a disk interface of the memory included in the host, a band usage rate of the disk interface included in the host, an input output command queue length with respect to a disk included in the host, a band usage amount of a network used by the host, a band usage rate of the network used by the host, and an input output queue length with respect to the network used by the host, other than the performance information illustrated in FIG. 5.

Further, the performance history list table 230 may include, as performance information, a total number of processes executed by a host and an operation status (e.g., information indicating abnormality or normality) of at least one of a specific process or a specific application.

Further, regarding performance information of the disk device included in the host and the network used by the host, performance information on an input and information on an output may be registered separately in the performance history list table 230. Regarding the performance information of the disk device included in the host and the network used by the host, performance information may be registered for each of the disk interface and the network interface.

The performance history list table 230 needs only to include performance information of at least one of various types of performance information described above.

Information registered in the performance history list table 230 is related to information registered in the operation list table 210, using identification information of a host registered in the host name 231 and identification information of a host registered in the operation target host name 214 of the operation list table 210 as keys.

Update processing of the performance history list table 230 is described below.

The performance monitoring program 108 possessed by a host included in a resource to be managed periodically acquires performance information of its own host and then transmits the acquired performance information to the performance history record program 121 of the management server 101. When receiving the performance information, the performance history record program 121 registers the received performance information in the performance history list table 230.

The performance monitoring program 108 may acquire periodically performance information of another host. Further, the performance history record program 121 of the management server 101 transmits periodically a performance information acquisition request to the performance monitoring program 108 of a host included in a resource to be managed, and when receiving the performance information acquisition request, the performance monitoring program 108 may acquire performance information of its own host to transmit the acquired performance information to the performance history record program 121.

The performance history record program 121 may not update automatically the performance history list table 230 and, for example, the system administrator may register information in the performance history list table 230 manually or using some kind of tool or utility.

Further, the server device 103, the storage device 104, and the network device 105 may hold the performance history list table 230.

FIG. 6 is an illustrative view of the performance threshold list table 240 of the first embodiment of the present invention.

The performance threshold list table 240 includes a performance type 241 and a threshold 242.

The performance type 241 registers a type of performance information included in the performance history list table 230. The threshold 242 registers a threshold for determining whether an operation procedure takes time manly for a manual procedure or an automatic execution procedure with respect to a type of each performance information.

The performance threshold list table 240 may store separately thresholds with respect to types of performance information of hosts.

Further, the system administrator previously registers the performance threshold list table 240. The system administrator may register the performance threshold list table 240 manually or using some kind of tool or utility.

FIG. 7 is an illustrative view of the configuration information list table 250 of the first embodiment of the present invention.

The configuration information list table 250 includes a business system name 251 and a host name list 252.

The business system name 251 registers identification information of a business system configured by a predetermined host. The host name list 252 registers identification information of a host configuring a business system.

The system administrator previously registers the configuration information list table 250. The system administrator may register the configuration information list table 250 manually or using some kind of tool or utility.

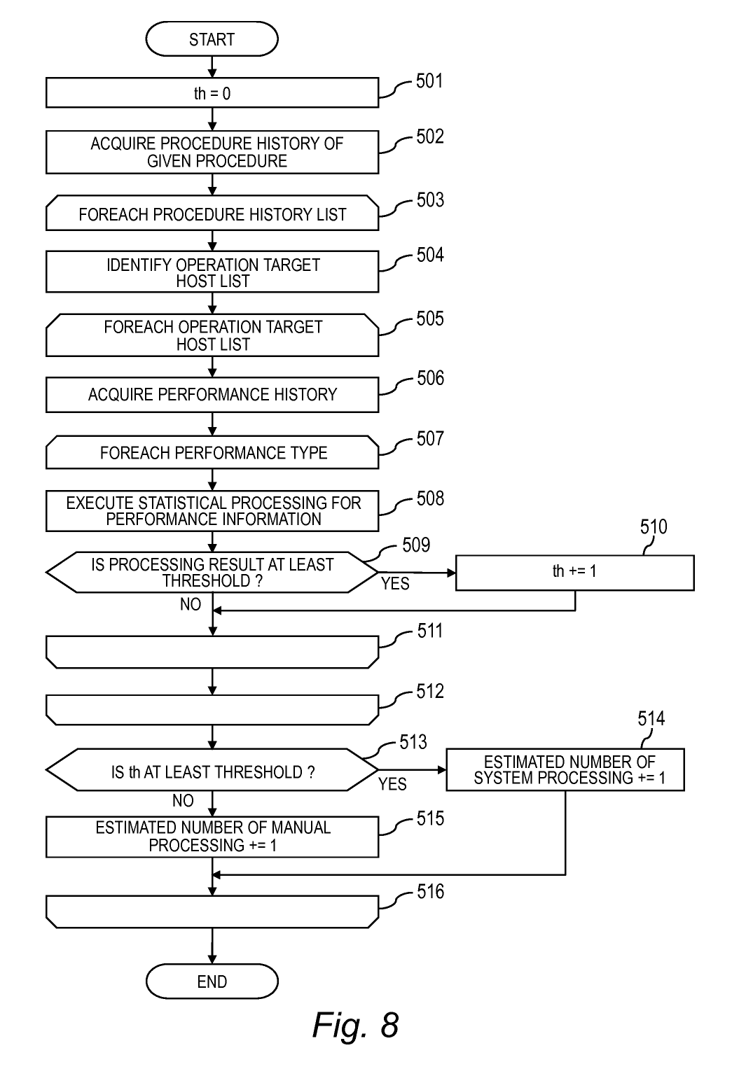

FIG. 8 is a flowchart of operation procedure determination processing of the first embodiment of the present invention.

The operation procedure determination processing is executed by the processor 200 included in the management server 101. The operation procedure determination processing is executed at a predetermined period by transmitting, as an argument, identification information of an operation registered in the operation ID 211 registered in the operation list table 210 to the procedure history acquisition program 122. An operation identified by identification information of the operation transmitted to the procedure history acquisition program 122 as an argument is referred to as an operation to be processed. The operation procedure determination processing may be executed at a timing other than the aforementioned timing.

Initially, the procedure history acquisition program 122 initializes to “0” a valuable th used for determining whether an operation procedure included in an operation to be processed is a system side procedure taking time mainly for an automatic execution procedure or an operator side procedure taking time mainly for a manual procedure (501).

Then, the procedure history acquisition program 122 acquires, as a procedure history, an entry in which identification information of an operation registered in the operation ID 221 of the procedure history list table 220 accords with identification information of an operation transmitted as an argument (502).

Then, the procedure history acquisition program 122 selects one procedure history for which the processing of Steps 504 to 516 has not been executed among procedure histories acquired by the processing of Step 502 as a procedure history to be processed (503). The processing of Steps 503 to 515 is repeatedly executed for all of the procedure histories acquired by the processing of Step 502.

Then, the operation target identification program 123 identifies identification information of a host having a possibility of having been applied with configuration modification processing by the procedure history to be processed selected by the processing of Step 503 (504).

Specifically, the operation target identification program 123 acquires identification information of an operation registered in the operation ID 221 of an entry of a procedure history to be processed and identification information of a procedure registered in the procedure number 222. Then, the operation target identification program 123 acquires identification information of hosts registered in the operation target host name 214 included in entries in which identification information of an operation registered in the operation ID 211 of the operation list table 210 accords with the acquired identification information of an operation registered in the operation ID 221 and also identification information of a procedure registered in the procedure number 212 accords with the acquired identification information of a procedure registered in the procedure number 222.

Then, the operation target identification program 123 identifies identification information of hosts registered in the host name list 252 of all entries, in which identification information of any one of the hosts registered in the host name list 252 of the configuration information list table 250 accords with the acquired identification information of the host, as identification information of hosts having a possibility of having been applied with configuration modification processing by the procedure history to be processed.

The reason why the processing of Step 504 is executed is described below. Hosts registered in the operation target host name 214 of entries of the operation list table 210 related to a procedure history to be processed are hosts to be operated by the operator but may not be hosts actually applied with configuration modification processing. A host other than the hosts to be operated may be applied with configuration modification processing. In such a case, even when determining whether an operation procedure is a system side procedure or an operator side procedure only based on performance information of a host to be operated, it is difficult that the management server 101 makes an accurate determination. Therefore, in the present embodiment, identification information of all hosts configuring the same business system as a host to be operated is identified.

Further, when the operation list table 210 does not include the operation target host name 214, the operation target identification program 123 may acquire identification information of a host to be operated by searching a character string registered in the operation guide 217 of an entry of the operation list table 210 related to a procedure history to be processed. Specifically, when the searched character string accords with identification information of a host registered in the host name list 252 of the configuration information list table 250, the operation target identification program 123 identifies the character string as identification information of the host.

Then, the operation target identification program 123 selects identification information of one host having not been applied with the processing of Step 506 to Step 511 from identification information of the hosts identified by the processing of Step 504 (505). The processing of Steps 505 to 511 is repeatedly executed for identification information of all of the hosts identified by the processing of Step 504.

Then, the performance acquisition program 124 acquires performance information of a host identified by identification information of the host selected by the processing of Step 505 by referring to the performance history list table 230 (506).

Specifically, the performance acquisition program 124 acquires performance information registered in the CPU usage rate 233, the memory usage rate 234, the disk IOPS 235, and the network IOPS 236 of an entry in which identification information of a host registered in the host name 231 of the performance history list table 230 accords with identification information of the host selected by the processing of Step 504.

Then, the performance acquisition program 124 selects performance information of one type having not been applied with the processing of Steps 508 to 510 among pieces of performance information acquired by the processing of Step 506(507). The processing of Steps 507 to 510 is repeatedly executed for performance information of all types identified by the processing of Step 506. Further, in processing of Step 507, the performance acquisition program 124 may select performance information of a predetermined type only.

Then, the system processing time estimation program 125 acquires performance information corresponding to an operation time of the procedure history to be processed selected by the processing of Step 503 from performance information of the type selected by the processing of Step 507, and executes statistical processing for the acquired performance information (508).

Performance information corresponding to the operation time of a procedure history to be processed includes, for example, a piece of performance information (first performance information) from a time registered in the initiation time 223 of an entry of the procedure history to be processed to a time before a predetermined time and a piece of performance information (second performance information) from the time registered in the initiation time 223 to a time after a predetermined time. An example of the predetermined time is 5 minutes. For example, as seen in a case where the predetermined time for acquiring the first performance information is 5 minutes and the predetermined time for acquiring the second performance information is 6 minutes, these predetermined times may differ.

Further, performance information corresponding to an operation time of a procedure history to be processed may include a piece of performance information (first performance information) from a time registered in the termination time 224 of an entry of the procedure history to be processed to a time before a predetermined time and a piece of performance information (second performance information) from the time registered in the termination time 224 to a time after a predetermined time.

Specifically, the system processing estimation program 125 executes, as statistical processing, processing for calculating a difference between the first performance information and the second performance information corresponding to the operation time of the procedure history to be processed. The difference between the first performance information and the second performance information indicates a variation in a load of a host before and after initiation of an operation by the operator.

Then, the system processing time estimation program 125 determines whether a statistical processing result of the processing of Step 508 is at least a threshold (509). When in the processing of Step 509, the statistical processing result of the processing of Step 508 has been determined to be at least the threshold, the system processing time estimation program 125 adds 1 to a value of the variable th (510), and then moves to the processing of Step 511. On the other hand, when in the processing of Step 509, the statistical processing result of the processing of Step 508 has been determined to be less than the threshold, the system processing time estimation program 125 moves to the processing of Step 511.

When the statistical processing result has been determined to be less than the threshold, the program may move to the processing of Step 510 and when the statistical processing result has been determined to be at least the threshold, the program may move to the processing of Step 511, depending on a calculation method of statistical processing. In other words, in the processing of Step 509, the system processing time estimation program 125 needs only to determine whether the statistical processing result of the processing Step 508 satisfies a predetermined condition. Then, when the statistical processing result of the processing Step 508 has been determined to satisfy the predetermined condition in the processing of Step 509, the program moves to the processing of Step 510, and when the statistical processing result of the processing Step 508 has been determined not to satisfy the predetermined condition in the processing of Step 509, the program moves to the processing of Step 511.

The processing of Step 509 is specifically described below.

Initially, the system processing time estimation program 125 acquires a threshold registered in the threshold 242 of an entry in which a type of performance information registered in the performance type 241 of the performance threshold list table 240 accords with the type of performance information selected by the processing of Step 507.

Then, the system processing time estimation program 125 determines whether the difference between the first performance information and the second performance information calculated by the processing of Step 508 is at least the acquired threshold. When in the processing of Step 509, the difference between the first performance information and the second performance information calculated by the processing of Step 508 has been determined to be at least the threshold, a load of a host varies to at least the threshold before and after operation initiation, and therefore, the system processing time estimation program 125 determines that configuration modification processing is being executed on the host side and then moves to the processing of Step 510 to add 1 to a value of the variable th. On the other hand, when in the processing of Step 509, the difference between the first performance information and the second performance information calculated by the processing of Step 508 has been determined to be less than the threshold, the load of the host varies only in a range of less than the threshold before and after operation initiation, and therefore, the system processing time estimation program 125 determines that configuration modification processing is not being executed on the host side and then does not add 1 to the value of the variable th.

Then, when the processing of Steps 508 to 510 has been executed for performance information of all of the types acquired by the processing of Step 506, the system processing time estimation program 125 moves to the processing of Step 512, and when the processing of Steps 508 to 510 has not been executed for performance information of all of the types acquired by the processing of Step 506, the system processing time estimation program 125 returns to the processing of Step 507 (511).

Then, when the processing of Steps 506 to 511 has been executed for identification information of all of the hosts identified by the processing of Step 504, the operation target identification program 123 moves to the processing of Step 513, and when the processing of Steps 506 to 511 has not been executed for identification information of all of the hosts identified by the processing of Step 504, the operation target identification program 123 returns to the processing of Step 505 (512).

Then, the system processing time estimation program 125 determines whether a value of the variable th is at least a preset threshold (513).

When in the processing of Step 513, the value of the variable th has been determined to be at least the present threshold, the number of pieces of performance information indicating that configuration modification processing is being executed on the host side is at least a predetermined number, and therefore, the system processing time estimation program 125 determines that a procedure history to be processed has been a system side procedure and adds 1 to the number of times registered in the estimated number of system processing 216 of an entry of the procedure history to be processed (514) to move to the processing of Step 516.

On the other hand, when in the processing of Step 513, the value of the variable th has been determined to be less than the present threshold, the number of pieces of performance information indicating that configuration modification processing is being executed on the host side is less than the predetermined number, and therefore, the system processing time estimation program 125 determines that the procedure history to be processed has been an operator side procedure and adds 1 to the number of times registered in the estimated number of manual processing 215 of the entry of the procedure history to be processed (515) to move to the processing of Step 516.

Before executing the processing of Step 513, in order to normalize a value of the variable th, the system processing time estimation program 125 may divide the variable th by at least one of a number of pieces of identification information of hosts identified in Step 504 or a number of types of performance information acquired by the processing of Step 506 to substitute the thus-divided value into the variable th.

Then, when the processing of Steps 504 to 516 has been executed for all of the procedure histories acquired by the processing of Step 502, the procedure history acquisition program 122 terminates operation procedure determination processing, and when the processing of Steps 504 to 516 has not been executed for all of the procedure histories acquired by the processing of Step 502, the procedure history acquisition program 122 returns to the processing of Step 503 (516).

In the above description, a method for executing statistical processing for a difference between two pieces of performance information before and after operation initiation (or operation termination) in the processing of Step 508 has been described but various types of modified examples are conceivable for this statistical processing. Modified examples of the statistical processing are described below.

Initially, a first modified example is described below.

In the processing of Step 508, the system processing time estimation program 125 acquires performance information from a time registered in the initiation time 223 of an entry of a procedure history to be processed to a time registered in the termination time 224 as performance information corresponding to an operation time of the procedure history to be processed selected by the processing of Step 503.

Then, the system processing time estimation program 125 executes processing for calculating an average value or a variance from the time registered in the initiation time 223 of the entry of the procedure history to be processed to the time registered in the termination time 224, as time statistical processing, for the acquired performance information corresponding to the operation time of the procedure history to be processed.

Next, a second modified example is described below.

In the processing of Step 508, in the same manner as in the first modified example, the performance history acquisition program 122 acquires performance information from a time registered in the initiation time 223 of an entry of a procedure history to be processed to a time registered in the termination time 224.

Then, the system processing time estimation program 125 executes processing for calculating a number of times or a ratio that is at least a threshold preset by the acquired performance information as statistical processing.

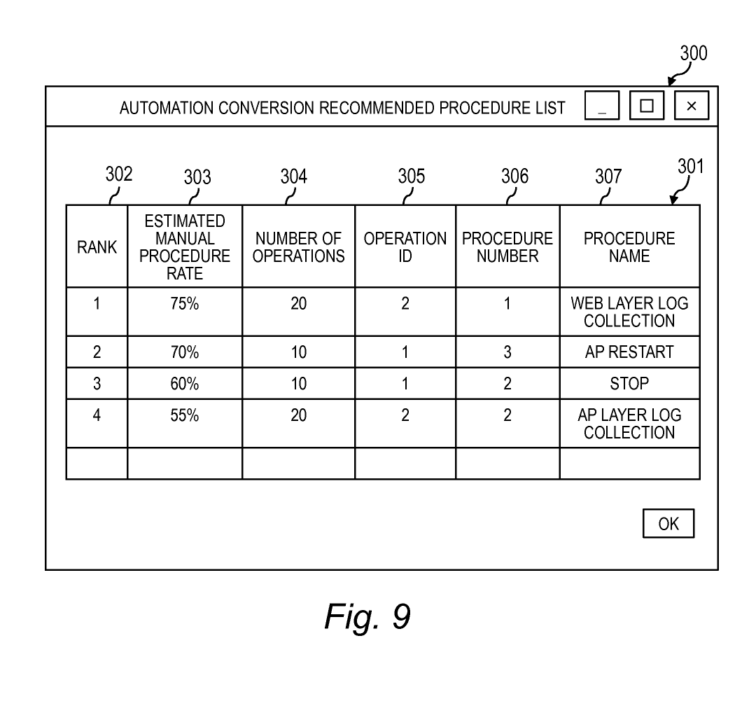

FIG. 9 is an illustrative view of a GUI screen 300 displayed in the output device 204 of the first embodiment of the present invention.

The GUI screen 300 is displayed in the output device 204 by the automation modification procedure display program 126 after the operation procedure determination processing illustrated in FIG. 8 is executed for each operation registered in the operation list table 210.

The GUI screen 300 includes an automation recommended procedure list display program 301 for recommending an operation procedure to be automated to the system administrator.

The automation recommended procedure list display program 301 includes a rank 302, an estimated manual processing ratio 303, a number of operations 304, an operation ID 305, a procedure number 306, and a procedure name 307.

A content displayed in the automation recommended procedure list display program 301 is generated by referring to the operation list table 210 by the automation modification procedure display program 126.

The rank 302 displays ranks provided in ascending order from 1 in higher ratio order displayed in the estimated manual processing ratio 303.

The estimated manual processing ratio 303 displays a ratio of a number of times where an operation procedure is determined as a manual procedure with respect to a number of times of the operation procedure operated. The ratio displayed in the estimated manual processing ratio 303 is calculated in such a manner that the automation modification procedure display program 126 refers to a number of times registered in the estimated number of manual processing 215 and a number of times registered in the estimated number of system processing 216 in the operation list table 210 and then calculates expression 1.

Estimated manual processing ratio=estimated number of manual processing/(estimated number of manual processing+estimated number of system processing)×100 (Expression 1)

The number of operations 304 displays a number of times where a manual procedure is operated. The number of times displayed in the number of operations 304 is calculated in such a manner that the automation modification procedure display program 126 calculates the sum of a number of times registered in the estimated number of manual processing 215 and a number of times registered in the estimated number of system processing 216 in the operation list table 210.

The operation ID 305, the procedure number 306, and the procedure name 307 display information registered in the operation ID 211, the procedure number 212, and the procedure name 213 in the operation list table 210, respectively.

The system administrator selects, as an operation procedure to be automated, an operation procedure having a higher ratio displayed in the estimated manual processing ratio 303 and a larger number of times displayed in the number of operations 304 by referring to the GUI screen 300.

The automation recommended procedure list display program 301 may include a display region other than the rank 302, the estimated manual processing ratio 303, the number of operations 304, the operation ID 305, the procedure number 306, and the procedure name 307 or may not include at least one of the rank 302, the estimated manual processing ratio 303, the number of operations 304, the operation ID 305, the procedure number 306, or the procedure name 307.

The automation recommended procedure list display program 301 may include, for example, at least one of an average time of times taken for manual setting procedures of respective operation procedures and a total time taken therefor. The average time of times taken for manual setting procedures of respective operation procedures is calculated by averaging times from a time registered in the initiation time 223 to a time registered in the termination time 224 of each operation procedure in the procedure history list table 220. Further, the total time taken for manual setting procedures of respective operation procedures is calculated in such a manner that the automation modification procedure display program 126 determines the sum of times from a time registered in the initiation time 223 to a time registered in the termination time 224 of each operation procedure in the procedure history list table 220.

Further, the GUI screen 300 may be displayed in an output device, not illustrated, of the operation terminal 110. Further, the automation modification procedure display program 126 may output information displayed in the automation recommended procedure list display program 301 to the storage device 208 in a format such as a file and the like, instead of displaying the GUI screen 300 in the output device 204.

In the present embodiment, the management server 101 determines whether an operation procedure is a host side procedure or an operator side procedure based on performance information corresponding to an operation procedure of a resource to be managed. Thereby, the system administrator can identify an operation procedure having a large number of times determined as the operator side procedure and can understand that when which operation procedure is automated, an operation time is efficiently reduced.

### Second Embodiment

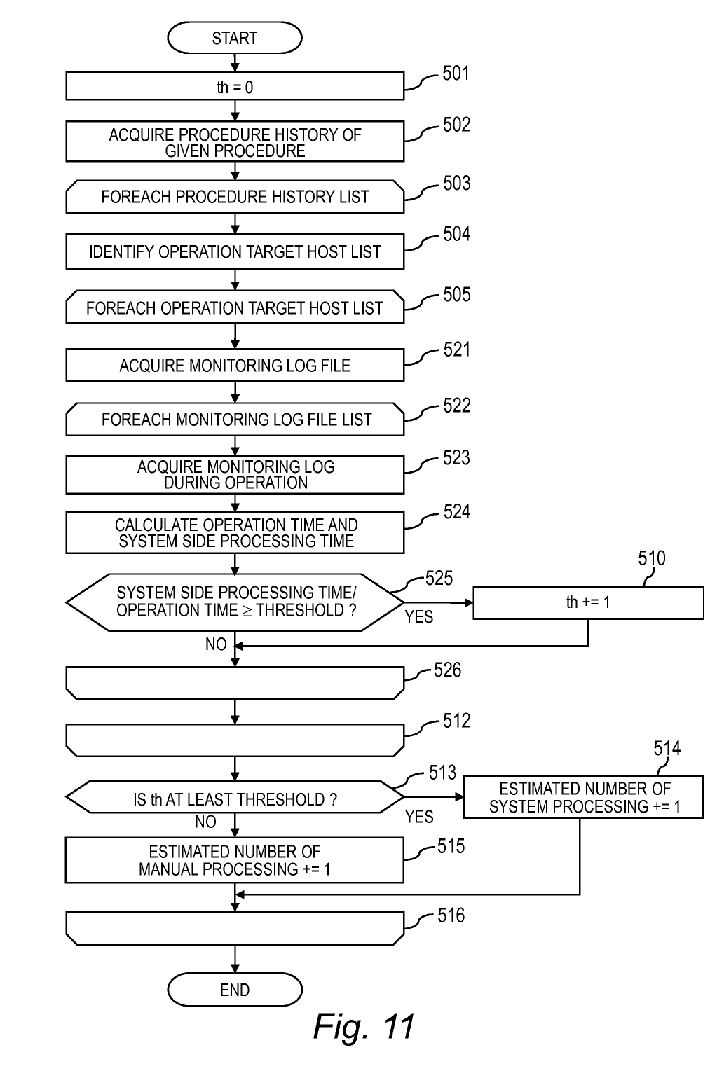

The second embodiment of the present invention will be described with reference to FIG. 10 and FIG. 11.

The management server 101 of the second embodiment of the present invention determines whether an operation procedure is a host side procedure or an operator side procedure based on a monitoring log file instead of performance information of a resource to be managed. The monitoring log file includes at least one monitoring log, and the monitoring log is information memorizing when which operator has performed what operation for which host and is used mainly for monitoring purposes. When configuration modification processing is executed by a host via an operation procedure operated by an operator, the monitoring log is output by an application executed on the host.

The log monitoring program 109 of each host periodically transmits a monitoring log file to the performance history record program 121 of the management server 101. When receiving the monitoring log file, the performance history record program 121 stores the received monitoring log file in the monitoring log file list 260 illustrated in FIG. 10.

Further, it is possible that the performance history record program 121 of the management server 101 periodically transmits a monitoring log file acquisition request to the log monitoring program 109 of a host included in a resource to be managed, and then when receiving the monitoring log file acquisition request, the log monitoring program 109 transmits a monitoring log file to the performance history record program 121.

FIG. 10 is an illustrative view of the monitoring log file list 260 of the second embodiment of the present invention.

The monitoring log file list 260 includes at least one monitoring log file. In each monitoring log file included in the monitoring log file list 260, one monitoring log is described in a single row.

The monitoring log includes a time 261, an operator 262, and a host name 263. The time 261 includes a date and a time when an application of a host has initiated executing configuration modification processing. The operator 262 is identification information of an operator having operated the host. The host name 263 is identification information of a host having been operated by the operator.

The data structure of the monitoring log file list 260 is not limited to the format illustrated in FIG. 10 and may be expressed by a data structure such as a list, a DB, a queue, and the like. Further, the monitoring log file list 260 may be expressed by a data structure other than a table, a list, a DB, and a queue.

FIG. 11 is a flowchart of operation procedure determination processing of the second embodiment of the present invention. In FIG. 11, the same sign is assigned to the same processing as in the operation procedure determination processing of the first embodiment illustrated in FIG. 8 and the description thereof will be omitted. In the operation procedure determination processing of the present embodiment, instead of the processing of Steps 506 to 509 illustrated in FIG. 8, the processing of Steps 521 to 525 is executed.

The performance acquisition program 124 refers to the monitoring log file list 260 and then acquires monitoring log files of hosts identified based on identification information of the hosts selected by the processing of Step 505 (521).

Specifically, the performance acquisition program 124 acquires monitoring log files corresponding to identification information of hosts in which the host names 263 have been selected by the processing of Step 505 from the monitoring log file list 260.

Then, of the monitoring log files acquired by the processing of Step 521, the performance acquisition program 124 selects one monitoring log file in which the processing of Steps 523 to 525 has not been executed (522). The processing of Steps 522 to 525 is repeatedly executed for all of the monitoring log files acquired by the processing of Step 521. In the processing of Step 522, the performance acquisition program 124 may select identification information of a predetermined host only.

Then, the system processing time estimation program 125 acquires a monitoring log in which the time 261 falls within a range from a time registered in the initiation time 223 of an entry of a procedure history to be processed to a time registered in the termination time 224 and also the operator 262 accords with identification information of an operator registered in the operator 225 of the entry of the procedure history to be processed, from the monitoring log file selected by the processing of Step 522 (523).

Then, the system processing time estimation program 125 calculates an operation time indicating a time taken for the procedure history to be processed and a system side processing time indicating a time taken for an automatic execution procedure of the procedure history to be processed (524).

Specifically, the system processing time estimation program 125 calculates, as the operation time, a time from a time registered in the initiation time 223 of the entry of the procedure history to be processed to a time registered in the termination time 224. Further, the system processing time estimation program 125 calculates, as the system side processing time, a time from the time 261 of the monitoring log acquired by the processing of Step 523 to a time registered in the termination time 224 of the entry of the procedure history to be processed.

Then, the system processing time estimation program 125 determines whether a divided value obtained by dividing the system side processing time by the operation time calculated by the processing of Step 524 is at least a preset threshold (525).

When the divided value has been determined to be at least the preset threshold in the processing of Step 525, the program moves to the processing of Step 510 and then the system processing time estimation program 125 adds 1 to a value of the variable th, followed by moving to the processing of Step 526.

On the other hand, when the divided value has been determined to be less than the preset threshold in the processing of Step 525, the system processing time estimation program 125 does not execute the processing of Step 510 and moves to the processing of Step 526.

When the processing of Steps 522 to 525 has been executed for all of the monitoring log files acquired by the processing of Step 521, the system processing time estimation program 125 moves to the processing of Step 512, and when the processing of Steps 522 to 525 has not been executed for all of the monitoring log files acquired by the processing of Step 521, the system processing time estimation program 125 returns to the processing of Step 522 (526).

Before executing the processing of Step 513, in order to normalize a value of the variable th, the system processing time estimation program 125 divides the variable th by at least one of a number of pieces of identification information of the hosts identified in Step 504 or a number of the types of performance information acquired by the processing of Step 506 to substitute the thus-divided value into the variable th.

Further, in the embodiment described above, description has been made on a case in which when the application has initiated configuration modification processing, a monitoring log is output, but conceivable is also a case in which when the application has initiated configuration modification processing, a monitoring log is output and also when the application has terminated configuration modification processing, a monitoring log is output. In this case, in the processing of Step 524, the system processing time estimation program 125 calculates, as a system side processing time, a time from the time 261 of the monitoring log indicating the initiation of configuration modification processing to the time 261 of the monitoring log indicating the termination of configuration modification processing.

In the present embodiment, the management server 101 determines whether an operation procedure is a host side procedure or an operator side procedure based on a monitoring log corresponding to an operation procedure of a resource to be managed. Thereby, the system administrator can identify an operation procedure having a large number of times determined as the operator side procedure and can understand that when which operation procedure is automated, an operation time is efficiently reduced.

### Third Embodiment

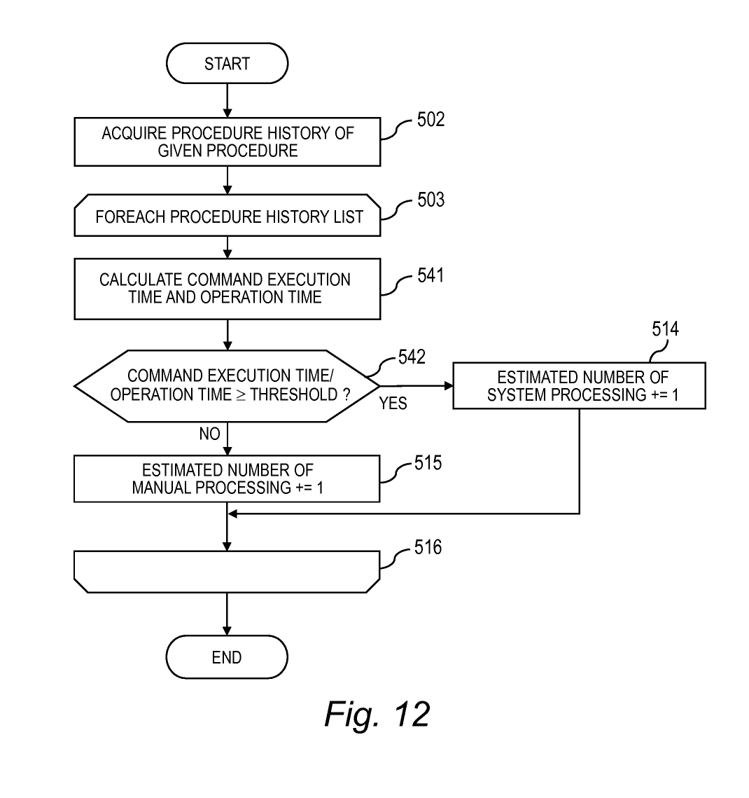

The third embodiment of the present invention will be described with reference to FIG. 12.

In the present invention, the management server 101 determines whether an operation procedure is a host side procedure or an operator side procedure, based on a command execution time from an input, by an operator, of a command executed by a resource to be managed into the resource to be managed via a remote connection tool to the termination of the execution of the command by the resource to be managed.

The remote connection tool 112 illustrated in FIG. 1 is connected to each host of a resource to be managed and transmits a command input by an operator to the each host. The remote connection tool 112 is, for example, a telnet client, an ssh client, or the like.

The remote connection tool 112 measures a command initiation time when a command input by the operator has been transmitted to the each host and a command termination time when command termination information indicating the termination of the execution of the command has been received from the host and then transmits command execution time information including these times and identification information of an operation procedure to which the command has been input.

When receiving the command execution time information, the procedure history record program 121 calculates a time from the command initiation time to the command termination time included in the received command execution time information as a command execution time and registers the calculated command execution time in the command execution time 226 of the procedure history list table 220.

FIG. 12 is a flowchart of operation procedure determination processing of the third embodiment of the present invention. In FIG. 12, the same sign is assigned to the same processing as in the operation procedure determination processing of the first embodiment illustrated in FIG. 8 and the description thereof will be omitted. In the operation procedure determination processing of the present embodiment, instead of the processing of Steps 504 to 513 illustrated in FIG. 8, the processing of Steps 541 and 542 is executed. Further, in the operation procedure determination processing of the present embodiment, the variable th is not used and therefore the processing of Step 501 illustrated in FIG. 8 is unnecessary.

The system processing time estimation program 125 acquires a time registered in the command execution time 226 of an entry of a procedure history to be processed selected by the processing of Step 503 and calculates, as an operation time, a time from a time registered in the initiation time 223 of the entry of the procedure history to be processed selected by the processing of Step 503 to a time registered in the termination time 224 (541).

Then, the system processing time estimation program 125 determines whether a divided value obtained by dividing the command execution time calculated by the processing of Step 541 by the operation time is at least a preset threshold (542).

When the divided value has been determined to be at least the preset threshold in the processing of Step 542, the program moves to the processing of Step 514, and then the system processing time estimation program 125 determines the procedure history to be processed to have been a system side procedure and adds 1 to a number of times registered in the estimated number of system processing 216 of the entry of the procedure history to be processed, followed by moving to the processing of Step 516.

On the other hand, when the divided value has been determined to be less than the preset threshold in the processing of Step 542, the system processing time estimation program 125 moves to the processing of Step 515, determines the procedure history to be processed to have been an operator side procedure and adds 1 to a number of times registered in the estimated number of manual processing 215 of the entry of the procedure to be processed (515), followed by moving to the processing of Step 516.

In the present embodiment, the management server 101 determines whether an operation procedure is a host side procedure or an operator side procedure based on a command execution time corresponding to an operation procedure of a resource to be managed. Thereby, the system administrator can identify an operation procedure having a large number of times determined as the operator side procedure and can understand that when which operation procedure is automated, an operation time is efficiently reduced.

The present invention has been described in detail with reference to the appended drawings. However, the present invention is not limited to such specific configurations and includes various modifications and equivalent configurations without departing from the spirit of the appended claims.

### INDUSTRIAL APPLICABILITY

Applications can be made to a management computer for managing a resource to be managed and for outputting an operation procedure to be automated from an operation procedure included in an operation for modifying a configuration of the resource to be managed.

What is claimed:

1. A management computer for managing a resource to be managed including at least one of a server device, a storage device, or a network device and for outputting an operation procedure to be automated from an operation procedure included in an operation for changing a configuration of the resource to be managed,
the operation procedure including a manual procedure that is a procedure manually operated by an operator and an automatic execution procedure where the resource to be managed executes configuration modification processing,
the management computer comprising:
a storage area for storing time information including an initiation time of initiating the operation procedure and a termination time of terminating the operation procedure and time-series information about the resource to be managed output by the resource to be managed; and
a processor for referring to the time information and the time-series information,
the processor being configured to:
acquire time-series information corresponding to the time information of the operation procedure from the time-series information,
determine whether the operation procedure takes time mainly for the manual procedure or takes time mainly for the automated procedure based on the acquired time-series information, and
output the determination result.

2. The management computer according to claim 1, wherein
the time-series information is time-series information of performance information of the resource to be managed; and
the processor is configured to;
acquire time-series information corresponding to the time information of the operation procedure from the time-series information based on at least one of the initiation time or the termination time,
execute statistical processing for the acquired time-series information,
determine whether the statistical processing result satisfies a predetermined condition,
determine that the operation procedure takes time mainly for the automatic execution procedure in a case where the statistical processing result is determined to satisfy the predetermined condition, and
determine that the operation procedure takes time mainly for the manual procedure in a case where the statistical processing result is determined not to satisfy the predetermined condition.

3. The management computer according to claim 2, wherein
the processor is configured to:
acquire two pieces of performance information before and after any one of the initiation time and the termination time as time-series information corresponding to the time information of the operation procedure, and
execute processing for calculating a difference between the acquired two pieces of performance information as the statistical processing.

4. The management computer according to claim 2, wherein
the processor is configured to:
acquire performance information between the initiation information and the termination information as time-series information corresponding to the time information of the operation procedure, and
execute processing for calculating at least one of an average value or a variance value of the acquired performance information as the statistical processing.

5. The management computer according to claim 2, wherein
the performance information is at least one of a usage rate of the processor included in the resource to be managed, a usage rate of a memory included in the resource to be managed, an IOPS of a disk included in the resource to be managed, an IOPS of an network used by the resource to be managed, a usage amount of the processor included in the resource to be managed, a queue length of the processor included in the resource to be managed, a usage amount of the memory included in the resource to be managed, a band usage amount of a disk interface included in the resource to be managed, a band usage rate of the disk interface included in the resource to be managed, an input output command queue length with respect to the disk included in the resource to be managed, a band usage rate of the network used by the resource to be managed, or an input output queue length with respect to the network used by the resource to be managed.

6. The management computer according to claim 1, wherein
the time-series information is a log including an execution time of the configuration modification processing executed by the resource to be managed; and
the processor is configured to:
acquire a log where the execution time is included in a range from the initiation time to the termination time of the operation procedure as time-series information corresponding to the time information of the operation procedure,
calculate a time taken for the automatic execution procedure based on the execution time included in the acquired log, and
determine whether the operation procedure takes time mainly for the manual procedure or takes time mainly for the automatic execution procedure based on the calculated time taken for the automatic execution procedure and the operation time of the operation procedure.

7. The management computer according to claim 1, wherein
the time-series information includes an initiation time when an operator terminal, which is coupled to the resource to be managed and operated by the operator, inputs a command for configuration modification processing of the operation procedure to the resource to be managed and a termination time when the resource to be managed terminates the execution of the configuration modification processing by the command; and
the processor is configured to:
calculate a time from the initiation time to the termination time of the time-series information as a time taken for the automatic execution procedure, and
determine whether the operation procedure takes time mainly for the manual procedure or takes time mainly for the automatic execution procedure based on the calculated time taken for the automatic execution procedure and the operation time of the operation procedure.

8. An automated operation procedure output method executed by a management computer for managing a resource to be managed including at least one of a server device, a storage device, or a network device, the method outputting an operation procedure to be automated from an operation procedure included in an operation for modifying a configuration of the resource to be managed,
the operation procedure including a manual procedure that is a procedure manually operated by an operator and an automatic execution procedure where the resource to be managed executes configuration modification processing,
the management computer storing time information including an initiation time of initiating the operation procedure and a termination time of terminating the operation procedure and time-series information about the resource to be managed output by the resource to be managed,
the method including:
an acquisition step where the management computer acquires time-series information corresponding to the time information of the operation procedure from the time-series information;
a determination step where the management computer determines whether the operation procedure takes time mainly for the manual procedure or takes time mainly for the automatic execution procedure based on the time-series information acquired in the acquisition step; and
an output step where the management computer outputs the determination result in the determination step.

9. The automated operation procedure output method according to claim 8, wherein
the time-series information is time-series information of performance information of the resource to be managed;
the acquisition step causes the management computer to acquire time-series information corresponding to the time information of the operation procedure from the time-series information based on at least one of the initiation time or the termination time; and
the determination step includes:
a step of causing the management computer to execute statistical processing for the acquired time-series information;
a step of causing the management computer to determine whether the statistical processing result satisfies a predetermined condition;
a step of causing the management computer to determine that the operation procedure takes time mainly for the automatic execution procedure in a case where the statistical processing result is determined to satisfy the predetermined condition; and
a step of causing the management computer to determine that the operation procedure takes time mainly for the manual procedure in a case where the statistical processing result is determined not to satisfy the predetermined condition.

10. The automated operation procedure output method according to claim 8, wherein
the time-series information is a log including an execution time of the configuration modification processing executed by the resource to be managed;
the acquisition step causes the management computer to acquire a log where the execution time is included in a range from the initiation time to the termination time of the operation procedure as time-series information corresponding to the time information of the operation procedure; and
the determination step includes:
a step of causing the management computer to calculate a time taken for the automatic execution procedure based on the execution time included in the acquired log; and
a step of causing the management computer to determine whether the operation procedure takes time mainly for the manual procedure or takes time mainly for the automatic execution procedure based on the calculated time taken for the automatic execution procedure and the operation time of the operation procedure.

11. The automated operation procedure output method according to claim 8, wherein
the time-series information includes an initiation time when an operator terminal, which is coupled to the resource to be managed and operated by the operator, inputs a command for configuration modification processing of the operation procedure to the resource to be managed and a termination time when the resource to be managed terminates the execution of the configuration modification processing by the command; and
the determination step includes:
a step of causing the management computer to calculate a time from the initiation time to the termination time of the time-series information as a time taken for the automatic execution procedure; and
a step of causing the management computer to determine whether the operation procedure takes time mainly for the manual procedure or takes time mainly for the automatic execution procedure based on the calculated time taken for the automatic execution procedure and the operation time of the operation procedure.

12. A computer-readable non-transitory storage medium for storing a program causing a processor to execute processing for outputting an operation procedure to be automated from an operation procedure included in an operation for changing a configuration of a resource to be managed in a management computer for managing the resource to be managed including at least one of a server device, a storage device, or a network device, the management computer including the processor and a storage region,
the operation procedure comprising a manual procedure that is a procedure manually operated by an operator and an automatic execution procedure where the resource to be managed executes configuration modification processing,
the management computer storing time information including an initiation time of initiating the operation procedure and a termination time of terminating the operation procedure and time-series information about the resource to be managed output by the resource to be managed in the storage region,
the processing causing the processor to:
acquire time-series information corresponding to the time information of the operation procedure from the time-series information;
determine whether the operation procedure taking a time from the initiation time to the termination time of the operation procedure takes time mainly for the manual procedure or takes time mainly for the automatic execution procedure based on the acquired time-series information; and
output the determination result.

13. The computer-readable non-transitory storage medium according to claim 12, wherein
the time-series information is time-series information of performance information of the resource to be managed; and
the processing causes the processor to:
acquire time-series information corresponding to the time information of the operation procedure from the time-series information based on at least one of the initiation time or the termination time;
execute statistical processing for the acquired time-series information;
determines whether the statistical processing result satisfies a predetermined condition;
determines that the operation procedure takes time mainly for the automatic execution procedure in a case where the statistical processing result is determined to satisfy the predetermined condition; and
determines that the operation procedure takes time mainly for the manual procedure in a case where the statistical processing result is determined not to satisfy the predetermined condition.

14. The computer-readable non-transitory storage medium according to claim 12, wherein
the time-series information is a log including an execution time of the configuration modification processing executed by the resource to be managed; and
the processing causes the processor to:
acquire a log where the execution time is included in a range from an initiation time to a termination time of the operation procedure as time-series information corresponding to the time information of the operation procedure;
calculate a time taken for the automatic execution procedure based on the execution time included in the acquired log; and
determine whether the operation procedure takes time mainly for the manual procedure or takes time mainly for the automatic execution procedure based on the calculated time taken for the automatic execution procedure and the operation time of the operation procedure.

15. The computer-readable non-transitory storage medium according to claim 12, wherein
the time-series information includes an initiation time when an operator terminal, which is coupled to the resource to be managed and operated by the operator, inputs a command for configuration modification processing of the operation procedure to the resource to be managed and a termination time when the resource to be managed terminates the execution of the configuration modification processing by the command; and
the processing causes the processor to:
calculate a time from an initiation time to a termination time of the time-series information as a time taken for the automatic execution procedure; and
determine whether the operation procedure takes time mainly for the manual procedure or takes time mainly for the automatic execution procedure based on the calculated time taken for the automatic execution procedure and the operation time of the operation procedure.
